(19) United States
(12) Patent Application Publication
(10) Pub. No.: US 2024/0250595 A1
(43) Pub. Date: Jul. 25, 2024

(54) POWER GENERATION MODULE

(71) Applicant: Mitsubishi Electric Corporation, Tokyo (JP)

(72) Inventors: Takeshi MUSHA, Tokyo (JP); Yasuyuki OKADA, Tokyo (JP)

(73) Assignee: Mitsubishi Electric Corporation, Tokyo (JP)

(21) Appl. No.: 18/290,307

(22) PCT Filed: May 18, 2021
(86) PCT No.: PCT/JP2021/018721

§ 371 Date: Nov. 13, 2023

(51) Int. Cl. H02K 35/02; H02J 7/14

(52) U.S. Cl. CPC H02K 35/02; H02J 7/14

(57) ABSTRACT

A power generation module includes a power generation element having a magnetic core elongated in one direction and a coil wound around the magnetic core, an induction yoke part having a first induction yoke contacting one end of the magnetic core in a longitudinal direction of the magnetic core and made of a magnetic material and a second induction yoke contacting the other end of the magnetic core in the longitudinal direction and made of a magnetic material, and a magnet part that is relatively displaceable relative to the power generation element in a direction perpendicular to the longitudinal direction. The magnet part has a first magnet and a second magnet arranged in the displacement direction. The first magnet has an N-pole part and an S-pole part arranged in the longitudinal direction. The second magnet has an N-pole part and an S-pole part arranged in the longitudinal direction. The N-pole part of the first magnet and the S-pole part of the second magnet face each other in the displacement direction, while the S-pole part of the first magnet and the N-pole part of the second magnet face each other in the displacement direction. When the magnet part is located in a first position relative to the power generation element, the N-pole part of the first magnet faces the first induction yoke, while the S-pole part of the first magnet faces the second induction yoke. When the magnet part is located in a second position relative to the power generation element, the S-pole part of the second magnet faces the first induction yoke, while the N-pole part of the second magnet faces the second induction yoke.

### TECHNICAL FIELD

The present disclosure relates to a power generation module.

### BACKGROUND ART

There have been conventionally known power generation technologies, called energy harvesting, that convert ambient energy into electric power. Among them, a vibration power generation technology is known to generate electric power through the vibration of humans or machines. For example, Patent Reference 1 discloses a power generation element that includes a cylindrical magnetic member elongated in one direction, a coil wound around the magnetic member, and a magnet disposed to face one end of the magnetic member in the longitudinal direction. The magnet is able to reciprocate in a direction perpendicular to the longitudinal direction of the magnetic member.

When the magnet reciprocates in the left-right direction due to vibration, magnetization reversal occurs in the magnetic member due to a large Barkhausen effect, and generates a pulse voltage in the coil.

### PRIOR ART REFERENCE

### Patent Reference

Patent Reference 1: International Publication No. WO 2018/097110 (see, for example, paragraphs 0027 to 0031, and FIG. 1)

### SUMMARY OF THE INVENTION

### Problem to be Solved by the Invention

However, in the above-described configuration, the magnetic flux from the magnet flows into only one end of the magnetic member and does not spread over the entire magnetic member. Thus, the magnetization reversal due to the large Barkhausen effect cannot occur through the entire magnetic material, and thus the amount of power generation is small.

The present disclosure is made to solve the above problem and an object of the present disclosure is to provide a power generation module that generates a large amount of power.

### Means of Solving the Problem

A power generation module of the present disclosure includes a power generation element having a magnetic core elongated in one direction and a coil wound around the magnetic core, an induction yoke part having a first induction yoke contacting one end of the magnetic core in a longitudinal direction of the magnetic core and made of a magnetic material and a second induction yoke contacting the other end of the magnetic core in the longitudinal direction and made of a magnetic material, and a magnet part that is relatively displaceable relative to the power generation element in a direction perpendicular to the longitudinal direction. The magnet part has a first magnet and a second magnet arranged in its displacement direction. The first magnet has an N-pole part and an S-pole part arranged in the longitudinal direction. The second magnet has an N-pole part and an S-pole part arranged in the longitudinal direction. The N-pole part of the first magnet and the S-pole part of the second magnet face each other in the displacement direction, while the S-pole part of the first magnet and the N-pole part of the second magnet face each other in the displacement direction. When the magnet part is located in a first position relative to the power generation element, the N-pole part of the first magnet faces the first induction yoke, while the S-pole part of the first magnet faces the second induction yoke. When the magnet part is located in a second position relative to the power generation element, the S-pole part of the second magnet faces the first induction yoke, while the N-pole part of the second magnet faces the second induction yoke.

### Effects of the Invention

According to the present disclosure, the magnetization reversal occurs in the magnetic core when the magnet part is located in the first position and in the second position relative to the power generation element. Since the magnetization reversal occurs over a wide area in the magnetic core, a larger amount of power can be obtained.

### BRIEF DESCRIPTION OF THE DRAWINGS

FIG. 1 is a perspective view illustrating a power generation module of a first embodiment.

FIG. 2 is a perspective view illustrating the power generation module of the first embodiment.

FIG. 3 is a perspective view illustrating a magnet part of the power generation module of the first embodiment.

FIG. 4 is a perspective view illustrating the magnet part, an induction yoke part, and a magnetic core in the power generation module of the first embodiment.

FIG. 5 is a cross-sectional view illustrating a configuration for restricting the position of the magnet part in the power generation module of the first embodiment.

FIG. 6 is a perspective view illustrating a configuration for holding the induction yoke part in the power generation module of the first embodiment.

FIG. 7 is a partial sectional perspective view illustrating the operation of the power generation module of the first embodiment.

FIG. 8 is a partial sectional perspective view illustrating the operation of the power generation module of the first embodiment.

FIG. 9 is a perspective view illustrating a power generation module of a second embodiment.

FIG. 10 is a partial sectional perspective view illustrating the operation of the power generation module of the second embodiment.

FIG. 11 is a partial sectional perspective view illustrating the operation of the power generation module of the second embodiment.

FIG. 12 is a perspective view illustrating the power generation module of a third embodiment.

FIG. 13 is a partial sectional perspective view illustrating the operation of the power generation module of the third embodiment.

FIG. 14 is a partial sectional perspective view illustrating the operation of the power generation module of the third embodiment.

FIG. 15 is a schematic view for explaining a mounting structure of an induction yoke part and a power generation element in the power generation module of the third embodiment.

FIG. 16 is a perspective view illustrating a power generation module of a fourth embodiment.

FIG. 17 is a partial sectional perspective view illustrating the operation of the power generation module of the fourth embodiment.

FIG. 18 is a partial sectional perspective view illustrating the operation of the power generation module of the fourth embodiment.

FIG. 19 is a perspective view illustrating a power generation module of a fifth embodiment.

FIG. 20 is a perspective view illustrating the operation of the power generation module of the fifth embodiment.

FIG. 21 is a block diagram illustrating an example of a processor of the power generation module of the fifth embodiment.

FIGS. 22(A) and 22(B) are perspective views illustrating examples of the shape of a housing of the power generation module of the fifth embodiment.

FIG. 23 is a block diagram illustrating another example of the processor of the power generation module of the fifth embodiment.

### MODE FOR CARRYING OUT THE INVENTION

### First Embodiment

### (Configuration of Power Generation Module)

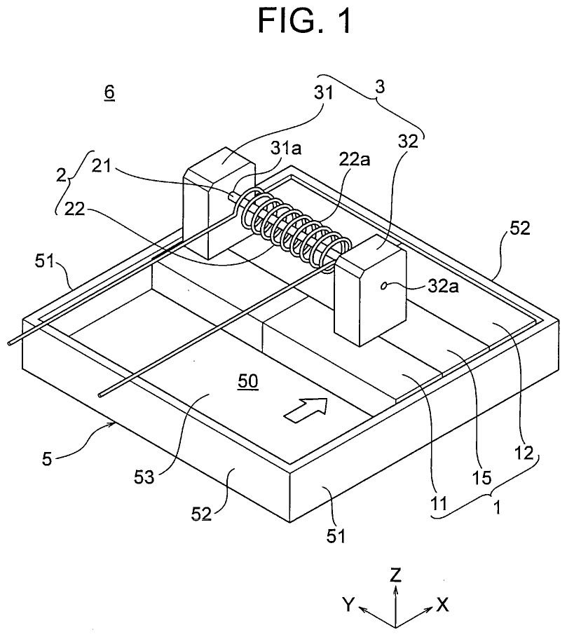

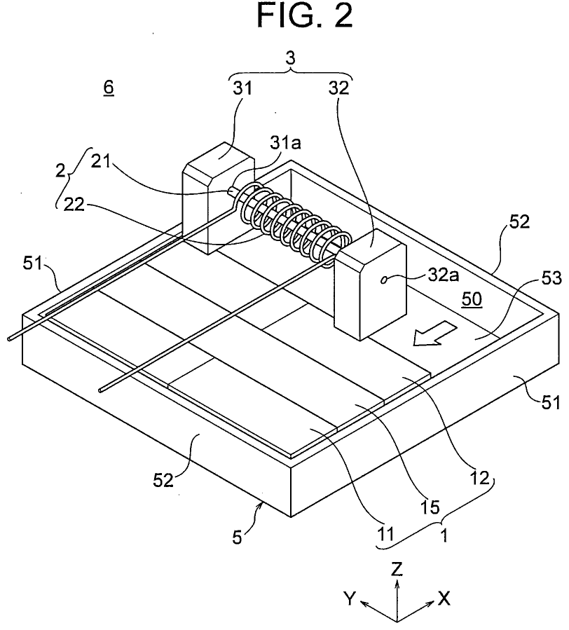

FIGS. 1 and 2 are perspective views illustrating a power generation module 6 of a first embodiment. As illustrated in FIG. 1, the power generation module 6 includes a magnet part 1, a power generation element 2, an induction yoke part 3, and a casing 5.

The power generation element 2 has a magnetic core 21 elongated in one direction and a coil 22 wound around the magnetic core 21. The extending direction of the magnetic core 21 is referred to as a Y direction. The magnetic core 21 is made of a magnetic material. The magnetic material refers to a material having a relative permeability of higher than 1.

More specifically, the magnetic core 21 is composed of a magnetic wire that exhibits a large Barkhausen effect. The large Barkhausen effect is a phenomenon in which the internal magnetization of the magnetic material simultaneously reverses near the boundary between an N pole and an S pole of a magnet. The magnetic wire that exhibits the large Barkhausen effect is, for example, an alloy wire called a Wiegand wire.

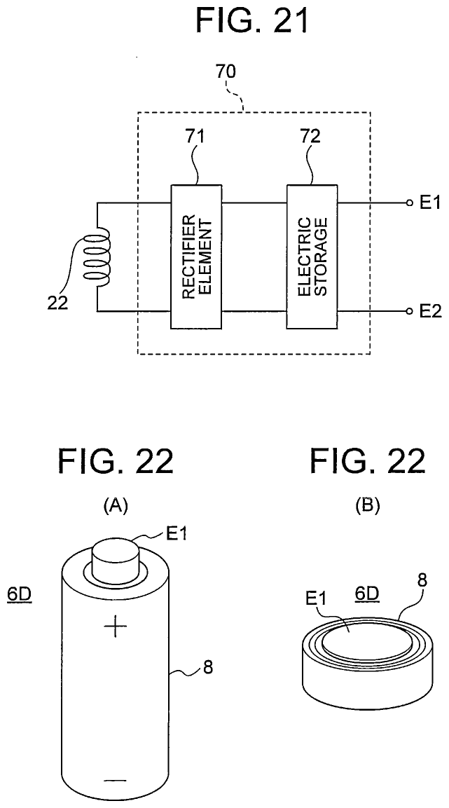

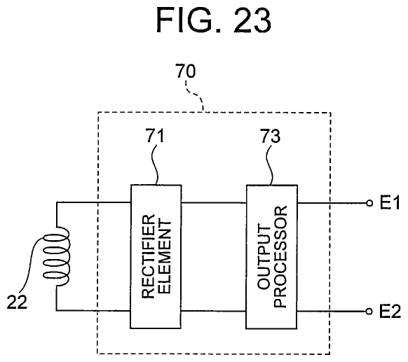

The coil 22 is wound to surround the magnetic core 21 so that its winding axis direction is oriented in the Y direction. Pulse voltage is generated in the coil 22 by electromagnetic induction due to the magnetization reversal in the magnetic core 21. The pulse voltage output from the coil 22 is rectified in a rectifier and supplied to an electric storage or the like. This will be described later with reference to FIGS. 21 and 23.

The magnet part 1 is displaceable in a direction perpendicular to the Y direction which is the longitudinal direction of the magnetic core 21. The displacement direction of the magnet part 1 is referred to as an X direction. The direction perpendicular to both the X and Y directions is referred to as a Z direction.

The magnet part 1 has a first magnet 11 and a second magnet 12 arranged side by side in the X direction. The first magnet 11 and the second magnet 12 are composed of permanent magnets. A spacer 15 made of a non-magnetic material is disposed between the first magnet 11 and the second magnet 12. The non-magnetic material refers to a substance having a relative permeability of 1.

The first magnet 11, the second magnet 12, and the spacer 15 are fixed integrally to form the magnet part 1. The fixing method is, for example, adhesion, integral molding, screw fastening, and fastening with a fastening band, but is not limited thereto.

Incidentally, the spacer 15 may be air if the first magnet 11 and the second magnet 12 are integrally displaceable in the X direction while maintaining a certain interval in the X direction between the first magnet 11 and the second magnet 12.

The casing 5 is made of a non-magnetic material, more specifically, a resin molded body. The casing 5 has a bottom plate 53 parallel to an XY plane, a pair of frames 51 located at both ends of the bottom plate 53 in the Y direction, and a pair of frames 52 located at both ends of the bottom plate 53 in the X direction. The magnet part 1 is held in a recess 50 enclosed by the frames 51 and 52 and the bottom plate 53.

The width of the recess 50 in the X direction, i.e., an interval between the frames 52 in the X direction, is wider than the width of the magnet part 1 in the X direction. Thus, the magnet part 1 is displaceable in the X direction within the recess 50.

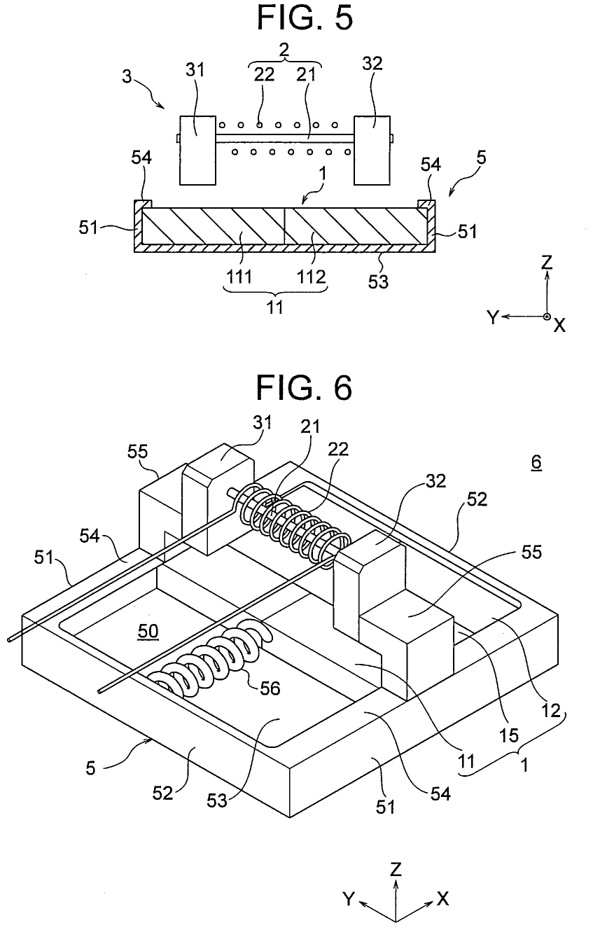

FIG. 1 illustrates a state in which the magnet part 1 is displaced in the +X direction, while FIG. 2 illustrates a state in which the magnet part 1 is displaced in the −X direction. The displacement amount of the magnet part 1 is at least double the interval between the first magnet 11 and the second magnet 12. The movement of the magnet part 1 in the +Z direction is restricted by guide parts 54 (FIG. 5) to be described later.

The induction yoke part 3 is disposed on the +Z side relative to a region where the magnet part 1 is displaced (in other words, movement range). In the state illustrated in FIG. 1, the first magnet 11 of the magnet part 1 faces the induction yoke part 3, whereas in the state illustrated in FIG. 2, the second magnet 12 faces the induction yoke part 3. The induction yoke part 3 is supported by the casing 5 as illustrated in FIG. 6 to be described later.

The induction yoke part 3 has a first induction yoke 31 and a second induction yoke 32 which extend in the Z direction. The first induction yoke 31 and the second induction yoke 32 face each other in the Y direction.

An end of the magnetic core 21 in the Y direction is in contact with the first induction yoke 31, and the other end of the magnetic core 21 in the Y direction is in contact with the second induction yoke 32. In this example, an end of the magnetic core 21 in the Y direction is fixed to a hole 31a formed in the first induction yoke 31, and the other end of the magnetic core 21 in the Y direction is fixed to a hole 32a formed in the second induction yoke 32.

Each of the first induction yoke 31 and the second induction yoke 32 is made of a magnetic material, more specifically a soft magnetic material, and has a relative permeability of higher than 1. That is, the relative permeability of each of the first induction yoke 31 and the second induction yoke 32 is higher than the relative permeability of air. The first induction yoke 31 and the second induction yoke 32 act to guide the magnetic flux generated by the magnet part 1 to the magnetic core 21.

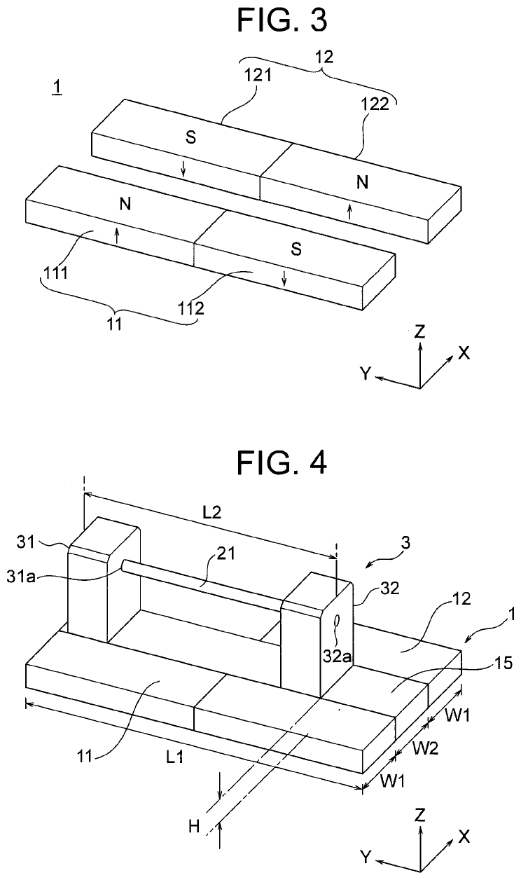

FIG. 3 is a perspective view illustrating the first magnet 11 and the second magnet 12. As illustrated in FIG. 3, the first magnet 11 has an N-pole part 111 and an S-pole part 112 arranged in the Y direction. The N-pole part 111 is disposed on the +Y side, while the S-pole part 112 is disposed on the −Y side. The magnetization directions of the N-pole part 111 and the S-pole part 112 are oriented in the Z direction, and are opposite to each other. The N-pole part 111 has an N-pole on the +Z-side end surface, and the S-pole part 112 has an S-pole on the +Z-side end surface.

The second magnet 12 has an S-pole part 121 and an N-pole part 122 arranged in the Y direction. The S-pole part 121 is disposed on the +Y side, while the N-pole part 122 is disposed on the −Y side. The magnetization directions of the S-pole part 121 and the N-pole part 122 are oriented in the Z direction, and are opposite to each other. The S-pole part 121 has an S-pole on the +Z-side end surface, and the N-pole part 122 has an N-pole on the +Z-side end surface.

FIG. 4 is a perspective view illustrating the positional relationship between the magnetic core 21 and induction yokes 31 and 32 and the magnet part 1. The first magnet 11 has a length L1 in the Y direction and a width W1 in the X direction. The same goes for the second magnet 12. A width W2 in the X direction of the spacer 15 is equal to the interval between the magnets 11 and 12 in the X direction.

The length L1 of each of the magnets 11 and 12 in the Y direction is desirably longer than or equal to a length L2 of the magnetic core 21 in the Y direction (L1≥L2). The width W2 of the spacer 15 in the X direction is desirably wider than or equal to the width W1 of each of the magnets 11 and 12 in the X direction (W2≥W1).

It is desirable that an interval H between the magnet part 1 and each of the induction yokes 31 and 32 in the Z direction is sufficiently narrower than the width W1 of each magnet 11, 12 (i.e., the width of each of the magnets 11 and 12), and sufficiently narrower than the width W2 of the spacer 15. In particular, the interval H is desirably narrower than or equal to ½ of the width W1 described above.

The width of each of the induction yokes 31 and 32 in the X direction is desirably narrower than or equal to the width W1 of each of the magnets 11 and 12. The present embodiment illustrates an example in which the width of each of the induction yokes 31 and 32 in the X direction is equal to the width W1 of each of the magnets 11 and 12.

FIG. 5 is a diagram illustrating an example of a configuration for restricting the position of the magnet part 1 in the casing 5. As illustrated in FIG. 5, the pair of frames 51 of the casing 5 are provided with guide parts 54 that restrict the position of the magnet part 1 to prevent the magnet part 1 from moving in the +Z direction. Not limited to the guide part 54, a member that restricts the position of the magnet part 1 to prevent the magnet part 1 from moving in the +Z direction may be provided.

FIG. 6 is a diagram illustrating an example of a configuration for holding the induction yokes 31 and 32. As illustrated in FIG. 6, the pair of frames 51 of the casing 5 are provided with yoke holders 55 that hold the induction yokes 31 and 32. The induction yokes 31 and 32 are held by the yoke holders 55 with the interval H (FIG. 4) in the +Z direction from the region where the magnet part 1 is displaced in the X direction. Not limited to the yoke holder 55, a member that holds the induction yokes 31 and 32 with the interval in the +Z direction from the magnet part 1 may be provided.

A spring 56 may be provided in the casing 5 as an urging member to urge the magnet part 1 in the +X direction or −X direction. By providing the spring 56, it is possible to obtain the effect of amplifying the displacement amount of the magnet part 1 when the casing 5 vibrates. The effect of the spring 56 will also be described in a fourth embodiment.

### (Action)

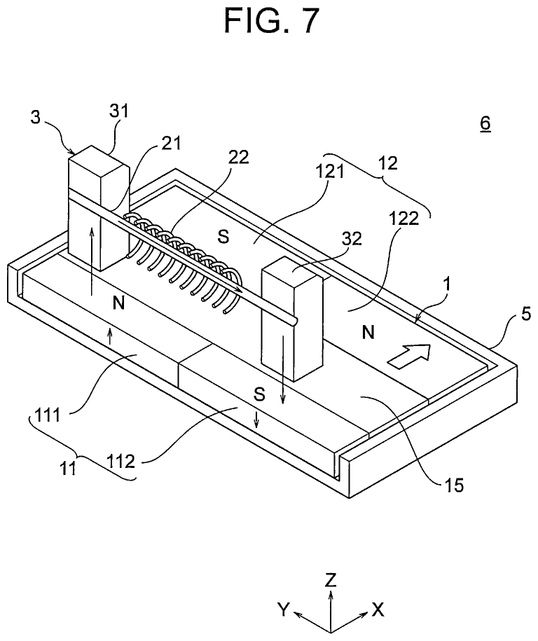

Next, the action of the power generation module 6 will be described. FIG. 7 is a partial sectional perspective view illustrating the power generation module 6 when the first magnet 11 faces the induction yoke part 3. The position of the magnet part 1 when the first magnet 11 faces the induction yoke part 3 is referred to as a first position.

When the magnet part 1 is located in the first position, the N-pole part 111 of the first magnet 11 faces the first induction yoke 31, and the S-pole part 112 of the first magnet 11 faces the second induction yoke 32.

The magnetic flux exiting from the N-pole part 111 of the first magnet 11 flows into the first induction yoke 31, which has a higher magnetic permeability than air, and then flows to the +Y-side end of the magnetic core 21 through the first induction yoke 31. Furthermore, the magnetic flux flows in the −Y direction in the magnetic core 21, flows into the second induction yoke 32 through the −Y-side end of the magnetic core 21, and then flows to the S-pole part 112 of the first magnet 11 through the second induction yoke 32.

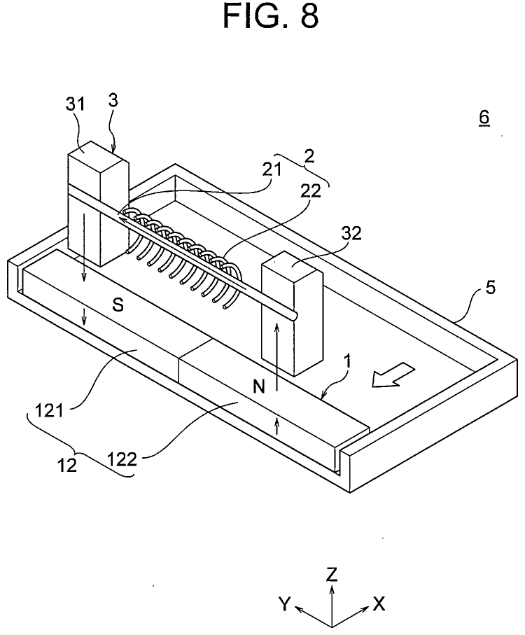

FIG. 8 is a partial sectional perspective view illustrating the power generation module 6 when the second magnet 12 faces the induction yoke part 3. The position of the magnet part 1 when the second magnet 12 faces the induction yoke part 3 is referred to as a second position.

When the magnet part 1 is located in the second position, the S-pole part 121 of the second magnet 12 faces the first induction yoke 31, and the N-pole part 122 of the second magnet 12 faces the second induction yoke 32.

The magnetic flux exiting from the N-pole part 122 of the second magnet 12 flows into the second induction yoke 32, which has a higher magnetic permeability than air, and then flows to the −Y-side end of the magnetic core 21 through the second induction yoke 32. Furthermore, the magnetic flux flows in the +Y direction in the magnetic core 21, flows into the first induction yoke 31 through the +Y-side end of the magnetic core 21, and then flows to the S-pole part 121 of the second magnet 12 through the first induction yoke 31.

In this way, the displacement of the magnet part 1 in the X direction causes the direction of the magnetic flux in the magnetic core 21 to reverse between the −Y direction and the +Y direction. Consequently, as for the magnetic flux φ flowing through the magnetic core 21, i.e., the magnetic flux φ T passing inside the coil 22, a change dφ/dt in the magnetic flux φ per hour increases. As a result, a high pulse voltage corresponding to an induced electromotive force V=−dφ/dt is output from the coil 22.

Previous experimental results have shown that particularly when a magnetic material exhibiting the large Barkhausen effect is used, the amount of magnetization reversal due to the large Barkhausen effect increases as the internal magnetic flux of the entire magnetic material changes. In the first embodiment, the magnetization reversal occurs over a wide area of the magnetic core 21. Thus, the amount of magnetization reversal is greater and a higher pulse voltage can be obtained, as compared to the configuration in which the magnetization reversal occurs only at the end of the magnetic member (for example, Patent Reference 1).

Since the length L1 of each of the magnets 11 and 12 in the Y direction is longer than or equal to the length L2 of the magnetic core 21 in the Y direction, the magnetic flux from each of the magnets 11 and 12 easily flows into the entire area of the magnetic core 21, and thus a higher pulse voltage can be generated.

In the configuration, such as that described in Patent Reference 1, where the distance between the magnet and the magnetic member is wider than the distance between the N pole and the S pole in the displacement direction of the magnet, there is a problem that a closed magnetic path is formed so that the magnetic flux from the N pole flows to the S pole without passing through the magnetic member, and thus magnetic flux flowing in the magnetic member is small.

In contrast, in the first embodiment, the interval H between the magnet part 1 and each of the induction yokes 31 and 32 in the Z direction is narrower than the interval between the magnets 11 and 12 in the X direction, i.e., the width W2 of the spacer 15. This allows most of the magnetic flux exiting from the N-pole part 111 of the first magnet 11 to flow into the induction yoke 31 and also allows most of the magnetic flux exiting from the N-pole part 122 of the second magnet 12 to flow into the induction yoke 32.

If the interval between the magnets 11 and 12 in the X direction is extremely narrow, the magnetic flux from the N-pole part 122 of the second magnet 12 may also flow into the second induction yoke 32 in a state where the S-pole part 112 of the first magnet 11 faces the second induction yoke 32 as illustrated in FIG. 7. In this case, the magnetic fluxes in the opposite directions cancel each other, and thus a change in the magnetic flux in the magnetic core 21 may decrease, and thus the magnetization reversal due to the large Barkhausen effect may decrease.

In the first embodiment, the interval between the magnets 11 and 12 in the X direction, i.e., the width W2 of the spacer 15, is wider than or equal to the width W1 of each of the magnets 11 and 12. Since the magnetic flux density is inversely proportional to the square of the distance from the magnet, it is possible to suppress the inflow of the magnetic flux into each of the induction yokes 31 and 32 from the magnet which do not face the induction yokes 31 and 32. Thus, magnetization reversal can be generated efficiently in the magnetic core 21, and a high pulse voltage can be generated.

Incidentally, the N-pole part 111 and the S-pole part 112 of the first magnet 11 do not necessarily have to be integral. As long as the N-pole part 111 is disposed to face the induction yoke 31 and the S-pole part 112 is disposed to face the induction yoke 32, the N-pole part 111 and the S-pole part 112 may be separate from each other. Similarly, the S-pole part 121 and the N-pole part 122 of the second magnet 12 do not necessarily have to be integral, but may be separate from each other.

The magnetic core 21 can also be made of a general soft magnetic material such as iron or permalloy (an alloy mainly composed of nickel and iron). In the power generation module 6 with the above configuration, the magnetic flux in the magnetic core 21 changes abruptly, and thus a certain level of pulse voltage can be generated even when the large Barkhausen effect is not used.

However, when the large Barkhausen effect is used, it is possible to obtain a constant amount of magnetization reversal regardless of the displacement speed of the magnet part 1, and it is also possible to further obtain the change in the magnetic flux during high-speed displacement of the magnet, which occurs in an ordinary soft magnetic material as well. For this reason, it is more desirable to use a magnetic wire having the large Barkhausen effect as the material for the magnetic core 21 of the power generation module 6.

In the first embodiment, the length of the recess 50 of the casing 5 in the X direction is made sufficiently longer than the length of the magnet part 1 in the X direction, so that the magnet part 1 can be displaced in the X direction. When an external force such as vibration is applied to the casing 5, such as when the user shakes the casing 5 with its hand, the magnet part 1 is displaced in the X direction, and a pulse voltage is generated.

However, the power generation module 6 of the first embodiment is not limited to such a configuration. The power generation module 6 only needs to be configured so that the magnet part 1 is displaced to face the induction yoke part 3 when an external force such as vibration is applied to the casing 5. For example, as described in a fifth embodiment, the casing 5 may be formed to have a cylindrical shape, and the magnet part 1 may be displaceable in the Z direction.

Although the above described power generation module 6 is configured so that the magnet part 1 is displaceable relative to the power generation element 2 and the induction yoke part 3, the same effects can be obtained when the power generation element 2 and the induction yoke part 3 are displaceable relative to the magnet part 1.

In this case, since the power generation element 2 and the induction yoke 3 each generally have a lower specific gravity and weight than the magnet part 1, it is desirable to increase the inertia force by attaching a weight to the power generation element 2 in order to obtain displacement by vibration. Since it is necessary to connect wires to the power generation element 2 for taking out the pulse voltage therefrom, it is more desirable that the magnet part 1 is displaceable in consideration of the risk of breakage of wires.

### Effects of Embodiment

As described above, the power generation module 6 of the first embodiment includes the magnet part 1, the power generation element 2, and the induction yoke part 3. The power generation element 2 has the magnetic core 21 elongated in the Y direction and the coil 22 wound around the magnetic core 21. The induction yoke part 3 has the first induction yoke 31 contacting one end of the magnetic core 21 in the Y direction and the second induction yoke 32 contacting the other end of the magnetic core 21 in the Y direction. The magnet part 1 is relatively displaceable relative to the power generation element 2 in the X direction and has the first magnet 11 and the second magnet 12 arranged in the X direction. The N-pole part 111 of the first magnet 11 and the S-pole part 121 of the second magnet 12 face each other in the X direction, while the S-pole part 112 of the first magnet 11 and the N-pole part 122 of the second magnet 12 face each other in the X direction. When the magnet part 1 is located in the first position relative to the power generation element 2, the N-pole part 111 of the first magnet 11 faces the first induction yoke 31, while the S-pole part 112 of the first magnet 11 faces the second induction yoke 32. When the magnet part 1 is located in the second position relative to the power generation element 2, the S-pole part 121 of the second magnet 12 faces the first induction yoke 31, while the N-pole part 122 of the second magnet 12 faces the second induction yoke 32.

With this configuration, the direction of the magnetic flux flowing to the magnetic core 21 of the power generation element 2 can be reversed between when the magnet part 1 is located in the first position relative to the power generation element 2 and when the magnet part 1 is located in the second position relative to the power generation element 2. Since the direction of the magnetic flux is reversed over a wide area of the magnetic core 21, a high pulse voltage can be generated.

Since the spacer 15 made of a non-magnetic material is provided between the first magnet 11 and the second magnet 12 in the X direction, only the magnetic flux from the magnet facing the induction yokes 31 and 32 can be guided to the magnetic core 21 through the induction yokes 31 and 32.

In particular, the width W2 of the spacer 15 in the X direction is wider than the width W1 of each of the magnets 11 and 12 in the X direction, and thus it is possible to effectively suppress the inflow of the magnetic flux into the induction yokes 31 and 32 from the magnet which do not face the induction yokes 31 and 32.

Furthermore, since the interval H, which is the shortest distance between the magnet part 1 and the induction yoke part 3, is narrower than the width W2 of the spacer 15 in the X direction, the magnetic flux exiting from the N-pole part of the first magnet 11 or the second magnet 12 can be prevented from being refluxed to the S-pole part without passing through the induction yoke part 3.

The casing 5 holds the magnet part 1 so that the magnet part 1 is displaceable in the X direction, the power generation element 2 and the induction yoke part 3 are fixed to the casing 5, and the magnet part 1 is displaceable by the distance which is at least double the interval between the magnets 11 and 12 in the X direction. Thus, the displacement of the magnet part 1 allows either the first magnet 11 or the second magnet 12 to face the induction yoke part 3.

By further providing the spring 56 that urges the magnet part 1 toward one side in the X direction, the displacement amount of the magnet part 1 due to vibration can be amplified, and a higher pulse voltage can be generated.

All the N-pole parts 111 and 122 and S-pole parts 112 and 121 of the magnets 11 and 12 have the magnetization direction in the Z direction, and they are disposed on one side in the Z direction relative to the first induction yoke 31 of the induction yoke part 3 and the magnet part 1. Therefore, the magnetic flux exiting from the N-pole parts 111 and 122 easily flows into the induction yokes 31 and 32, respectively.

### Second Embodiment

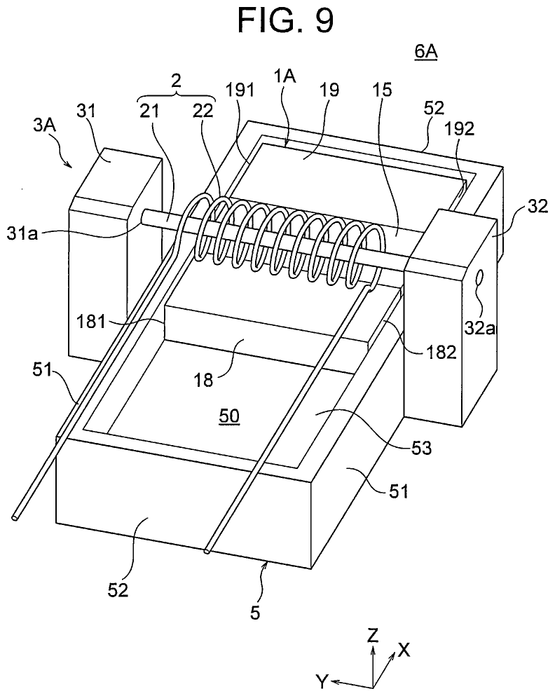

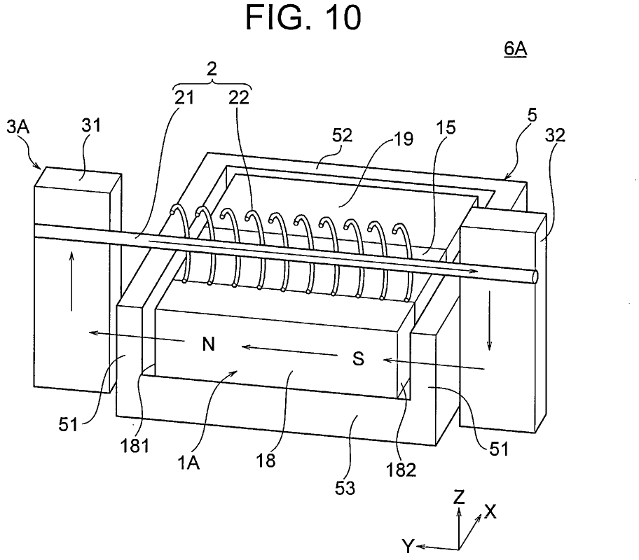

Next, a second embodiment will be described. FIG. 9 is a perspective view illustrating a power generation module 6A of the second embodiment. The power generation module 6A includes a magnet part 1A, the power generation element 2, an induction yoke part 3A, and the casing 5. The second embodiment differs from the first embodiment in the configuration of the magnet part 1A and the induction yoke part 3A.

The magnet part 1A has a first magnet 18, a second magnet 19, and a spacer 15 between the magnets 18 and 19, which are arranged in the X direction. The magnetization direction of the first magnet 18 is the Y direction, and the magnetization direction of the second magnet 19 is also the Y direction. The configuration of the spacer 15 is as described in the first embodiment.

FIG. 10 is a partial sectional perspective view illustrating the power generation module 6A. As illustrated in FIG. 10, the first magnet 18 is magnetized so that one end thereof in the +Y direction forms an N-pole part 181 and the other end thereof in the −Y direction forms an S-pole part 182.

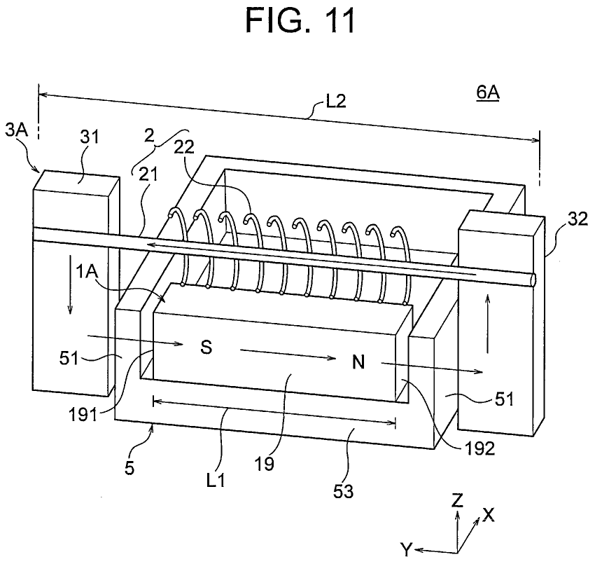

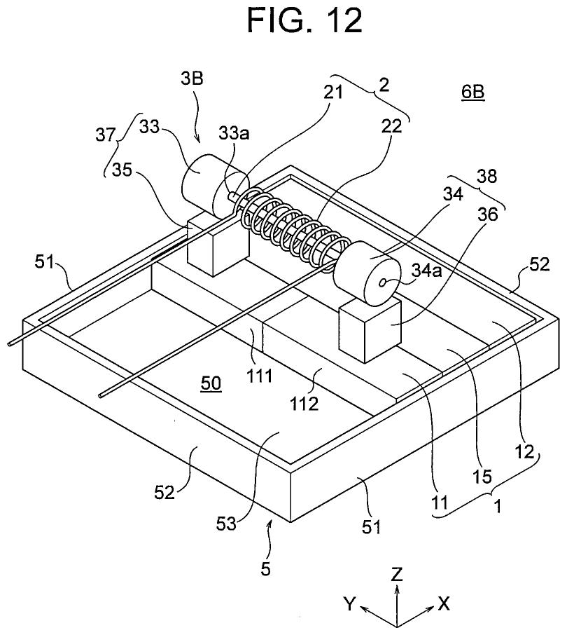

FIG. 11 is a partial sectional perspective view illustrating the power generation module 6A when the magnet part 1A is displaced from the position illustrated in FIG. 9 in the −X direction. As illustrated in FIG. 11, the second magnet 19 is magnetized so that one end thereof in the +Y direction forms an S-pole part 191 and the other end thereof in the −Y direction forms an N-pole part 192.

As illustrated in FIG. 9, the first induction yoke 31 of the induction yoke part 3A is disposed to face the end of the magnet part 1A in the +Y direction, via the frame 51. The second induction yoke 32 of the induction yoke part 3A is disposed to face the end of the magnet part 1A in the −Y direction, via the frame 51.

The first induction yoke 31 and the second induction yoke 32 both extend in the Z direction. The first induction yoke 31 and the second induction yoke 32 are provided with the holes 31a and 32a to which both ends of the magnetic core 21 of the power generation element 2 in the Y direction are fixed. The configuration of the power generation element 2 is as described in the first embodiment.

In FIG. 10, the first magnet 18 of the magnet part 1A faces the induction yokes 31 and 32. That is, the magnet part 1A is located in the first position. At this time, the N-pole part 181 of the first magnet 18 faces the first induction yoke 31, while the S-pole part 182 of the first magnet 18 faces the second induction yoke 32.

The magnetic flux exiting from the N-pole part 181 of the first magnet 18 flows into the first induction yoke 31, and flows to the +Y-side end of the magnetic core 21 through the first induction yoke 31. Furthermore, the magnetic flux flows in the −Y direction in the magnetic core 21, flows into the second induction yoke 32 through the −Y-side end of the magnetic core 21, and flows to the S-pole part 182 of the first magnet 18 through the second induction yoke 32.

In FIG. 11, the second magnet 19 of the magnet part 1A faces the induction yokes 31 and 32. That is, the magnet part 1A is located in the second position. At this time, the S-pole part 191 of the second magnet 19 faces the first induction yoke 31, while the N-pole part 192 of the second magnet 19 faces the second induction yoke 32.

The magnetic flux exiting from the N-pole part 192 of the second magnet 19 flows into the second induction yoke 32, and flows to the −Y side end of the magnetic core 21 through the second induction yoke 32. Furthermore, the magnetic flux flows in the +Y direction in the magnetic core 21, flows into the first induction yoke 31 through the +Y-side end of the magnetic core 21, and flows to the S-pole part 191 of the second magnet 19 through the first induction yoke 31.

In this way, the displacement of the magnet part 1A in the X direction causes the direction of the magnetic flux in the magnetic core 21 to alternately reverse in the −Y and +Y directions. Thus, a high pulse voltage can be output from the coil 22, as in the first embodiment.

In other respects, the power generation module 6A of the second embodiment is configured in the same manner as the power generation module 6 of the first embodiment.

In the second embodiment, the induction yokes 31 and 32 are disposed on both sides of the magnet part 1A in the X direction, and thus the length L1 of the magnet part 1A in the Y direction can be shorter than the length L2 of the magnetic core 21 in the Y direction as illustrated in FIG. 11. By reducing the size and weight of the magnet part 1A which is a movable part, the reduction in the size of the power generation module 6A can be achieved. In addition, since the magnet part 1A is displaced with a smaller force, electric power can be generated with a smaller vibration force (i.e., power generation energy).

As described in the first embodiment, the magnetic core 21 may be made of a soft magnetic material such as iron or permalloy, but a magnetic wire having the large Barkhausen effect is more desirable. Instead of the configuration in which the magnet part 1A is displaced relative to the power generation element 2 and the induction yoke part 3A, the same effect can be obtained by the configuration in which the power generation element 2 and the induction yoke part 3A are displaceable relative to the magnet part 1A.

### Third Embodiment

Next, a third embodiment will be described. FIG. 12 is a perspective view illustrating a power generation module 6B of the third embodiment. The power generation module 6B includes the magnet part 1, the power generation element 2, an induction yoke part 3B, and the casing 5. The third embodiment differs from the first embodiment in the configuration of the induction yoke part 3B.

In the third embodiment, the induction yoke part 3B has a first induction yoke 33, a second induction yoke 34, a third induction yoke 35, and a fourth induction yoke 36. Each of the induction yokes 33, 34, 35, and 36 is made of a magnetic material, more specifically, a soft magnetic material.

The first induction yoke 33 and the second induction yoke 34 are disposed to contact both ends of the magnetic core 21 in the Y direction. The third induction yoke 35 is disposed on the −Z side of the first induction yoke 33. The fourth induction yoke 36 is disposed on the −Z side of the second induction yoke 34.

In this example, each of the first induction yoke 33 and the second induction yoke 34 has a cylindrical shape about the magnetic core 21. The first induction yoke 33 and the second induction yoke 34 have holes 33a and 34a to which both ends of the magnetic core 21 are fixed. Each of the third induction yoke 35 and the fourth induction yoke 36 has a rectangular parallelepiped shape.

The first induction yoke 33 and the third induction yoke 35 constitute a +Y-side induction yoke unit 37. The second induction yoke 34 and the fourth induction yoke 36 constitute a −Y-side induction yoke unit 38.

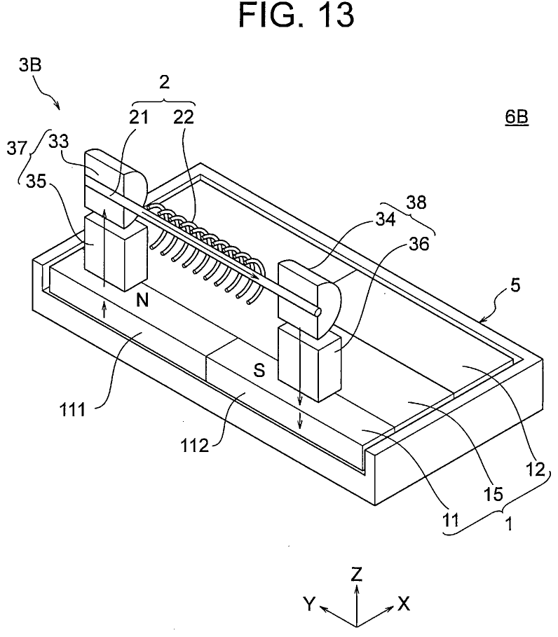

FIG. 13 is a partial sectional perspective view illustrating a state in which the first magnet 11 and the induction yoke part 3B face each other. In FIG. 13, the magnet part 1 is located in the first position. At this time, the N-pole part 111 of the first magnet 11 faces the third induction yoke 35, while the S-pole part 112 of the first magnet 11 faces the fourth induction yoke 36.

The magnetic flux exiting from the N-pole part 111 of the first magnet 11 flows into the third induction yoke 35, which has a higher magnetic permeability than air, then flows into the first induction yoke 33, and flows therefrom to the +Y-side end of the magnetic core 21. Furthermore, the magnetic flux flows in the −Y direction in the magnetic core 21, flows into the second induction yoke 34 through the −Y-side end of the magnetic core 21, then flows into the fourth induction yoke 36, and flows therefrom to the S-pole part 112 of the first magnet 11.

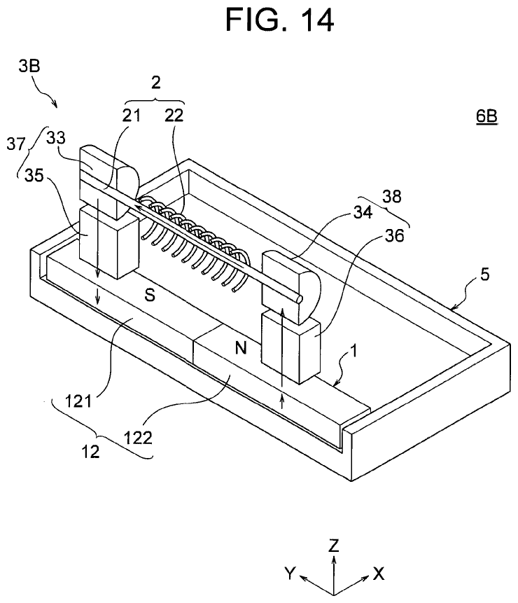

FIG. 14 is a partial sectional perspective view illustrating a state in which the magnet part 1 is moved in the −X direction from the position illustrated in FIG. 13, and the second magnet 12 faces the induction yoke part 3B. In FIG. 14, the magnet part 1 is located in the second position. At this time, the S-pole part 121 of the second magnet 12 faces the third induction yoke 35, while the N-pole part 122 of the second magnet 12 faces the fourth induction yoke 36.

The magnetic flux exiting from the N-pole part 122 of the second magnet 12 flows into the fourth induction yoke 36, which has a higher magnetic permeability than air, then flows into the second induction yoke 34, and flows therefrom to the −Y-side end of the magnetic core 21. Furthermore, the magnetic flux flows in the +Y direction in the magnetic core 21, flows into the first induction yoke 33 through the +Y-side end of the magnetic core 21, then flows into the third induction yoke 35, and flows therefrom to the S-pole part 121 of the second magnet 12.

In this way, the displacement of the magnet part 1 in the X direction causes the direction of the magnetic flux in the magnetic core 21 to alternately reverse in the −Y and +Y directions, and thus a high pulse voltage can be output from the coil 22, as in the first embodiment.

In the third embodiment, the induction yoke part 3B is constituted by the first induction yoke 33, the second induction yoke 34, the third induction yoke 35, and the fourth induction yoke 36, and thus the following effects are obtained.

The dimension and shape (hereinafter referred to as a dimension/shape) of the magnet part 1 can be designed relatively flexibly in accordance with the dimensional constraints of the power generation module 6B. In contrast, the dimension/shape of the induction yoke part 3B facing the magnet part 1 needs to be optimized in accordance with the dimension/shape of the magnet part 1.

Since the casing 5 has a portion that holds the induction yoke part 3B, the dimension/shape of the casing 5 needs to be determined in consideration of the dimension/shape of the induction yoke part 3B. Thus, a molding die for molding the casing 5 must be prepared for each dimension/shape of the magnet part 1.

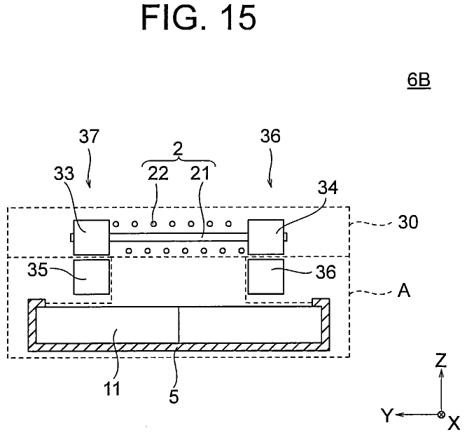

In the third embodiment, the induction yoke part 3B is composed of the four induction yokes 33 to 36. Thus, as illustrated as an example in FIG. 15, the power generation element 2, the first induction yoke 33 and the second induction yoke 34 can be housed in one package 30. Meanwhile, the third induction yoke 35 and the fourth induction yoke 36 can be mounted on the casing 5.

The dimensions/shapes of the third induction yoke 35 and the fourth induction yoke 36, which are the parts facing the magnet part 1, are optimized in accordance with the dimension/shape of the magnet part 1. In contrast, the package 30 including the power generation element 2, the first induction yoke 33, and the second induction yoke 34 only needs to have one type of dimension and shape regardless of the dimension and shape of the magnet part 1.

Thus, the power generation module 6B compatible with a plurality of shapes of the magnet part 1 can achieved by one type of package 30. This makes it possible to reduce the cost of the power generation module 6B.

The mounting of the third induction yoke 35 and the fourth induction yoke 36 on the casing 5 can be performed using the yoke holder 55 or the like illustrated in FIG. 6, as indicated by the dashed line A in FIG. 15.

Since the induction yoke part 3B is constituted by the four induction yokes 33 to 36, the first and second induction yokes 33 and 34 can be composed of ferrite beads. Since ferrite beads are inexpensive and commercially available, the component cost of the induction yoke part 3B can be reduced.

The first induction yoke 33 and the second induction yoke 34 are cylindrical, and the general ferrite beads are also cylindrical. Thus, ferrite beads can be used without any process. Further, since the general ferrite beads have holes at their center, there is no need to perform a process for forming the holes 33a and 34a into which the magnetic core 21 is inserted.

The third induction yoke 35 and the fourth induction yoke 36 are, for example, rectangular parallelepiped, and thus are easily processed. The third induction yoke 35 and the fourth induction yoke 36 do not need to be subjected to the process for forming holes into which the magnetic core 21 is inserted, and further cost reduction can be achieved.

In other respects, the power generation module 6B of the third embodiment is configured in the same way as the power generation module 6 of the first embodiment.

According to the third embodiment, the first induction yoke 33 and the second induction yoke 34 can be made of inexpensive materials, and the third induction yoke 35 and the fourth induction yoke 36 can be formed in the simple shape, such as a rectangular parallelepiped, in accordance with the dimension/shape of the magnet part 1. Thus, the cost reduction of the power generation module 6B can be enabled.

### Fourth Embodiment

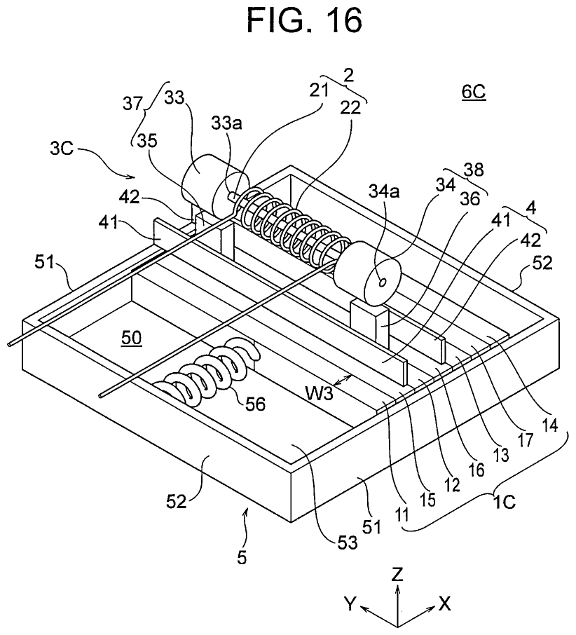

Next, the fourth embodiment will be described. FIG. 16 is a perspective view illustrating a power generation module 6C of the fourth embodiment. The power generation module 6C has a magnet part 1C, the power generation element 2, an induction yoke part 3C, a shield 4, and the casing 5. The fourth embodiment differs from the third embodiment in the configuration of the magnet part 1C and the provision of the shield 4.

The magnet part 1C has a first magnet 11, a second magnet 12, a third magnet 13, and a fourth magnet 14 which are arranged in the X direction. A width W3 of each of the magnet 11, 12, 13, 14 in the X direction (i.e., the width of each of the magnets 11, 12, 13, and 14 in the X direction) is narrower than the width W1 of each of the magnets 11 and 12 in the X direction in the first embodiment, and is, for example, ½ of the width W1.

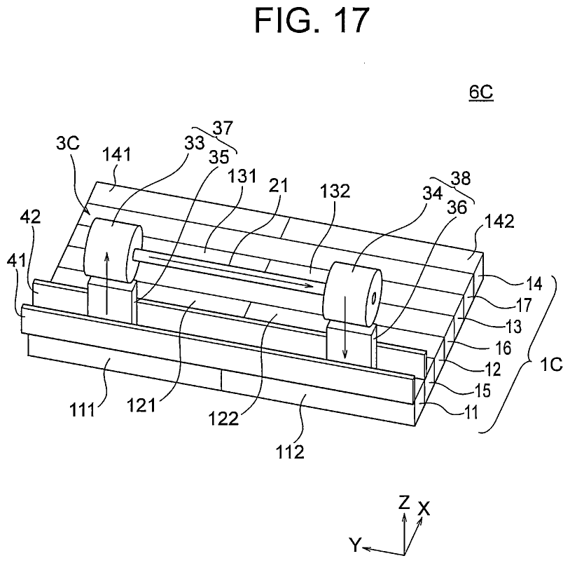

FIG. 17 is a diagram illustrating the magnet part 1C, the magnetic core 21, and the induction yoke part 3C. As illustrated in FIG. 17, the first magnet 11 has an N-pole part 111 on the +Y side and an S-pole part 112 on the −Y side, as in the first magnet 11 of the first embodiment. The second magnet 12 has an S-pole part 121 on the +Y side and an N-pole part 122 on the −Y side, as in the second magnet 12 of the first embodiment.

The third magnet 13 has an N-pole part 131 on the +Y side and an S-pole part 132 on the −Y side, as in the first magnet 11. The fourth magnet 14 has an S-pole part 141 on the +Y side and an N-pole part 142 on the −Y side, as in the second magnet 12.

A spacer 15 is disposed between the first magnet 11 and the second magnet 12, a spacer 16 is disposed between the second magnet 12 and the third magnet 13, and a spacer 17 is disposed between the third magnet 13 and the fourth magnet 14.

Each of the spacers 15, 16, and 17 is made of a non-magnetic material. The width of each of the spacers 15, 16, and 17 in the X direction only needs to be thicker than or equal to the width W3 (FIG. 16) of each of the magnets 11, 12, 13, and 14.

As illustrated in FIG. 16, the magnets 11 to 14 are integrally fixed via the spacers 15 to 17 to form the magnet part 1C. The magnet part 1C is housed in the recess 50 of the casing 5. The length of the recess 50 in the X direction is longer than the length of the magnet part 1C in the X direction, and thus the magnet part 1C is displaceable in the X direction in the recess 50.

The induction yoke part 3C has a first induction yoke 33, a second induction yoke 34, a third induction yoke 35, and a fourth induction yoke 36, as in the induction yoke part 3B of the third embodiment.

The width of each of the induction yokes 35 and 36 in the X direction is desirably narrower than or equal to the width W3 of each of the magnets 11, 12, 13, and 14. The present embodiment shows an example in which the width of each of the induction yokes 35 and 36 in the X direction is equal to the width W3 of each of the magnets 11, 12, 13, and 14.

Shielding yokes 41 and 42 are provided on both sides of the induction yoke part 3C in the X direction. The shielding yokes 41 and 42 are located on the +Z side relative to the magnet part 1C, and form the shield 4. Each of the shielding yokes 41 and 42 is made of a magnetic material, more specifically, a soft magnetic material.

Each of the shielding yokes 41 and 42 is in the form of a flat plate, and has a thickness in the X direction, a length in the Y direction, and a width in the Z direction. However, each of the shielding yokes 41 and 42 is not limited to such a shape and may be prismatic, for example.

The length of each of the shielding yokes 41 and 42 in the Y direction is desirably longer than or equal to the total of the lengths in the Y direction of the N-pole part and the S-pole part of each of the magnets 11 to 14.

The interval between the shielding yoke 41 and the induction yoke part 3C in the X direction can be adjusted according to the shape and magnetic force of the magnets 11 to 14. In this example, the interval between the induction yoke part 3C and the shielding yoke 41 is ½ of the width W3 of each of the magnets 11 to 14. The same goes for the interval between the induction yoke part 3C and the shielding yoke 42.

In the state illustrated in FIG. 17, the first magnet 11 of the magnet part 1C faces the induction yoke part 3C. The magnet part 1C is located in the first position. At this time, the N-pole part 111 of the first magnet 11 faces the third induction yoke 35, while the S-pole part 112 of the first magnet 11 faces the fourth induction yoke 36.

The magnetic flux exiting from the N-pole part 111 of the first magnet 11 flows into the third induction yoke 35, then flows into the first induction yoke 33, and flows therefrom to the +Y-side end of the magnetic core 21. Furthermore, the magnetic flux flows in the −Y direction in the magnetic core 21, flows into the second induction yoke 34 through the −Y-side end of the magnetic core 21, then flows into the fourth induction yoke 36, and flows therefrom to the S-pole part 112 of the first magnet 11.

FIG. 18 is a diagram illustrating the magnet part 1C, the magnetic core 21, and the induction yoke part 3C when the second magnet 12 faces the induction yoke part 3C. The magnet part 1C is located in the second position. At this time, the S-pole part 121 (FIG. 17) of the second magnet 12 faces the third induction yoke 35, while the N-pole part 122 (FIG. 17) of the second magnet 12 faces the fourth induction yoke 36.

The magnetic flux exiting from the N-pole part 122 of the second magnet 12 flows into the fourth induction yoke 36, then flows into the second induction yoke 34, and flows therefrom to the −Y-side end of the magnetic core 21. Furthermore, the magnetic flux flows in the +Y direction in the magnetic core 21, flows into the first induction yoke 33 through the +Y-side end of the magnetic core 21, then flows into the third induction yoke 35, and flows therefrom to the S-pole part 121 of the second magnet 12.

Similarly, when the third magnet 13 faces the induction yoke part 3C, the magnetic flux flows in the −Y direction in the magnetic core 21. When the fourth magnet 14 faces the induction yoke part 3C, the magnetic flux flows in the +Y direction in the magnetic core 21.

In the fourth embodiment, the width and interval of each of the magnets 11 to 14 in the X direction are narrower than those in the first embodiment. Thus, the displacement amount of the magnet part 1C required for occurrence of magnetization reversal in the magnetic core 21 is smaller than that in the first embodiment, and is, for example, half that in the first embodiment. That is, power can be generated with a smaller displacement amount of the magnet part 1C.

However, as the distance between the N and S poles in the X direction decreases, the magnetic flux may flow into the induction yoke part 3C from the magnetic pole which does not face the induction yoke part 3C. For example, in FIG. 18, the magnetic flux may flow into the third induction yoke 35 of the induction yoke part 3C from the N-pole part 111 of the first magnet 11 or the N-pole part 131 of the third magnet 13 (FIG. 7). When the inflow of the magnetic flux from the adjacent magnets 11 and 13 occurs, the amount of the magnetic flux flowing through the magnetic core 21 is reduced.

In order to suppress the inflow of the magnetic flux into the adjacent magnets 11 and 13, it is conceivable to dispose the induction yoke part 3C closer to the magnet part 1C in the Z direction. However, the magnetic attraction force acts between the induction yoke part 3C and the magnet part 1C, and therefore a lid or guide may be provided between the magnet part 1C and the induction yoke part 3C. In this case, there is a limit to disposing the induction yoke part 3C closer to the magnet part 1C.

Therefore, in the fourth embodiment, the above-described shielding yokes 41 and 42 are disposed on both sides of the induction yoke part 3C in the X direction.

As illustrated in FIG. 18, when the second magnet 12 faces the induction yoke part 3C, the magnetic flux exiting from the N-pole part 111 of the first magnet 11 flows into the first shielding yoke 41 located closer thereto than the induction yoke part 3C. The magnetic flux flowing into the first shielding yoke 41 further flows in the −Y direction, and flows to the S-pole part 112 of the first magnet 11.

Similarly, the magnetic flux from the N-pole part 131 (FIG. 17) of the third magnet 13 flows to the S-pole part 132 through the second shielding yoke 42. That is, the magnetic flux from the first magnet 11 and the third magnet 13 does not flow to the induction yoke part 3C.

In this way, only the magnetic flux from the second magnet 12, which faces the induction yoke part 3C, flows to the magnetic core 21 through the induction yoke part 3C.

Similarly, when the first magnet 11 faces the induction yoke part 3C (FIG. 17), the inflow of the magnetic flux from the adjacent second magnet 12 into the induction yoke part 3C is shielded by the shielding yoke 42.

When the third magnet 13 faces the induction yoke part 3C, the inflow of the magnetic flux from the adjacent magnets 12 and 14 into the induction yoke part 3C is shielded by the shielding yokes 41 and 42. When the fourth magnet 14 faces the induction yoke part 3C, the inflow of the magnetic flux from the adjacent third magnet 13 into the induction yoke part 3C is shielded by the shielding yoke 41.

As a result, the displacement of the magnet part 1C in the X direction efficiently causes the magnetization reversal in the magnetic core 21, and thus a high pulse voltage in the coil 22 can be generated.

In the configuration, such as that described in Patent Reference 1, where a magnet is disposed on one end side of the magnetic member in the longitudinal direction and the magnet reciprocates in a direction perpendicular to the longitudinal direction of the magnetic member, only one reversal of the magnetic field occurs in the magnetic member per one reciprocation of the magnet. Thus, the number of times of power generation is small.

In order to generate power a plurality of times with a single reciprocation of the magnet, it is conceivable to increase the number of poles of the magnets. However, when the number of poles of the magnets is increased, the magnetic flux flows into the magnetic member from the pole which does not face the magnetic member, and thus the reversal of the magnetic flux in the magnetic member is less likely to be generated by the displacement of the magnet.

In the fourth Embodiment, the intervals between adjacent ones of the magnets 11 to 14 are made narrow, and the shielding yokes 41 and 42 are provided on both sides of the induction yoke part 3C in the X direction. Thus, the magnetization reversal in the magnetic core 21 can be generated by a small displacement of the magnet part 1C. That is, the number of times of power generation can be increased, and a high pulse voltage can be generated.

In other respects, the power generation module 6C of the fourth embodiment is configured in the same manner as the power generation module 6 of the first embodiment.

In this example, the spacers 15 to 17 are disposed between the magnets 11 to 14. However, depending on the arrangement of the shielding yokes 41 and 42, the magnets 11 to 14 can be disposed adjacent to each other without disposing the spacers 15 to 17. In this case, power can be generated by a smaller displacement of the magnet part 1C.

In this example, the configuration of the induction yoke part 3C is the same as that of the induction yoke part 3B in the third embodiment. However, the configuration of the induction yoke part 3C may be the same as that of the induction yoke part 3 in the first embodiment or the induction yoke part 3A in the second embodiment.

As in the first and third embodiments, the magnet part 1C has the magnets 11 to 14 in each of which two magnetic pole parts (for example, the N-pole part 111 and the S-pole part 112) having the magnetization directions in the Z direction are arranged in the Y direction. However, it is possible to use magnets having magnetization directions in the Y direction, as in the magnets 18 and 19 (FIGS. 10 and 11) of the second embodiment.

The shielding yokes 41 and 42 are provided on both sides of the induction yoke part 3C in this example, but effect can be obtained to some extent by providing at least one of the shielding yokes 41 and 42. Furthermore, although the magnet part 1C has four magnets 11, 12, 13, and 14 in this example, the magnet part 1C may have more magnets.

As illustrated in FIG. 16, the spring 56 as an urging member may be attached to the magnet part 1C. The spring 56 serves to amplify the displacement amount of a vibrating body to which the spring 56 is attached. In the case where the vibration frequency of the vibrating body, i.e., the magnet part 1C, is known, the displacement amount of the magnet part 1C due to small vibration of the magnet part 1C can be maximized by setting a spring constant so that the natural frequency of the spring 56 is equal to the vibration frequency of the magnet part 1C. It is also effective to use a material with a heavier specific gravity for the spacer 15 or attach a weight to the magnet part 1C to thereby increase the inertia force so as to increase the displacement amount of the spring 56.

### Fifth Embodiment

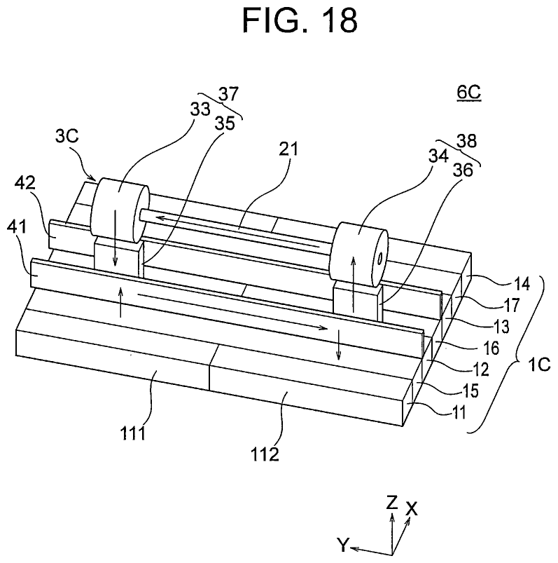

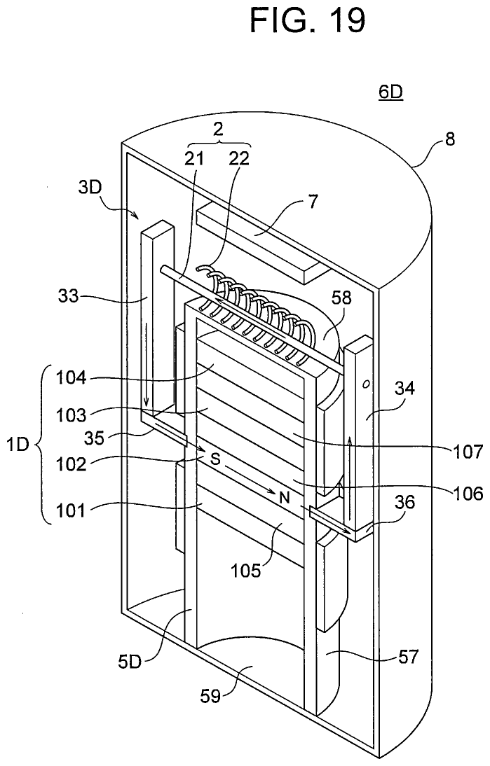

Next, a fifth embodiment will be described. FIG. 19 is a partial sectional perspective view illustrating a power generation module 6D of the fifth embodiment. The power generation module 6D includes a magnet part 1D, the power generation element 2, an induction yoke part 3D, a casing 5D, and a housing 8.

In the power generation module 6D of the fifth embodiment, the displacement direction of the magnet part 1D is the Z direction. The casing 5D is cylindrical about an axis in the Z direction.

The magnet part 1D has disc-shaped magnets 101, 102, 103, and 104, which are arranged in the Z direction. Each of the magnets 101, 102, 103, and 104 has the magnetization direction in the Y direction, as in the magnets 18 and 19 (FIGS. 10 and 11) in the second embodiment.

In this example, the magnetization direction of the first magnet 101 is the +Y direction, the magnetization direction of the second magnet 102 is the −Y direction, the magnetization direction of the third magnet 103 is the +Y direction, and the magnetization direction of the fourth magnet 104 is the +Y direction.

A spacer 105 is disposed between the magnets 101 and 102, a spacer 106 is disposed between the magnets 102 and 103, and a spacer 107 is disposed between the magnets 103 and 104. Each of the spacers 105 to 107 is disc-shaped and made of a non-magnetic material.

The magnets 101 to 104 and the spacers 105 to 107 are fixed integrally to constitute the cylindrical magnet part 1D. The width of each of the magnets 101 to 104 in the Z direction and the width of each of the spacers 105 to 107 in the Z direction are as described in the fourth embodiment.

The casing 5D is a container which is cylindrical about the axis in the Z direction as described above and encloses the magnet part 1D from its outer peripheral side. The casing 5D has a peripheral wall 57, a bottom part 58, and a ceiling part 59. The distance in the Z direction from the bottom part 58 to the ceiling part 59 is longer than the length of the magnet part 1D in the Z direction, and the magnet part 1D is displaceable in the Z direction within the casing 5D. The casing 5D is made of a non-magnetic material.

The induction yoke part 3D has the first induction yoke 33, the second induction yoke 34, the third induction yoke 35, and the fourth induction yoke 36. The third induction yoke 35 and the fourth induction yoke 36 are disposed on the +Y side and the −Y side of the casing 5D, respectively, and are fixed to the peripheral wall 57.

The first induction yoke 33 extends in the +Z direction from the tip of the third induction yoke 35. The second induction yoke 34 extends in the +Z direction from the tip of the fourth induction yoke 36. Both ends of the magnetic core 21 of the power generation element 2 in the Y direction are fixed to the induction yokes 33 and 34.

The power generation element 2 has the magnetic core 21 and the coil 22 wound around the magnetic core 21 as described in the first embodiment.

The housing 8 is a cylindrical container that encloses the magnet part 1D, the power generation element 2, the induction yoke part 3D, and the casing 5D. The housing 8 is desirably made of a non-magnetic material. A circuit board 7 connected to the coil 22 is provided inside the housing 8.

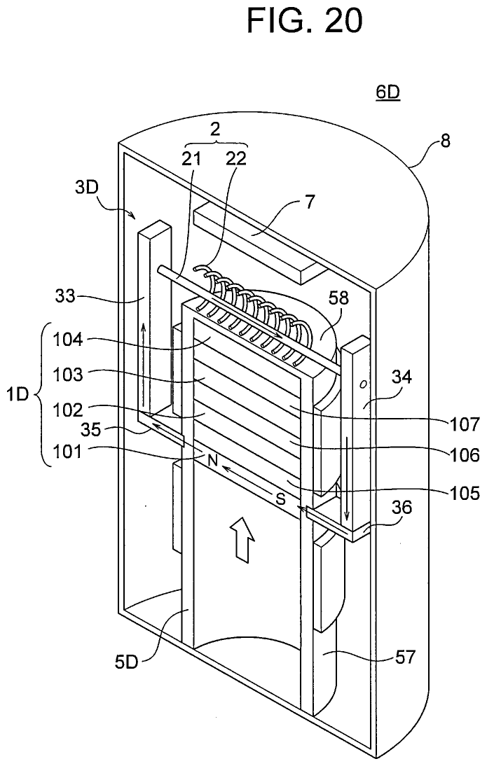

FIG. 20 illustrates a state in which the magnet part 1D is moved in the +Z direction from the position illustrated in FIG. 19, and the first magnet 101 faces the yokes 35 and 36 of the induction yoke part 3D. The magnet part 1D is located in the first position. At this time, the N-pole part of the first magnet 101 faces the third induction yoke 35, while the S-pole part of the first magnet 101 faces the fourth induction yoke 36.

The magnetic flux exiting from the N-pole part of the first magnet 101 flows into the third induction yoke 35, and flows to the +Y-side end of the magnetic core 21 through the first induction yoke 33. Furthermore, the magnetic flux flows in the −Y direction in the magnetic core 21, flows into the second induction yoke 34 through the −Y-side end of the magnetic core 21, and flows to the S-pole part of the first magnet 101 through the fourth induction yoke 36.

In FIG. 19 described above, the second magnet 102 faces the yokes 35 and 36 of the induction yoke part 3D. The magnet part 1D is located in the second position. At this time, the N-pole part of the second magnet 102 faces the fourth induction yoke 36, while the S-pole part thereof faces the third induction yoke 35.

The magnetic flux exiting from the N-pole part of the second magnet 102 flows into the fourth induction yoke 36, and flows to the −Y-side end of the magnetic core 21 through the second induction yoke 34. Furthermore, the magnetic flux flows in the +Y direction in the magnetic core 21, flows into the first induction yoke 33 through the +Y-side end of the magnetic core 21, and flows to the S-pole part of the second magnet 102 through the third induction yoke 35.

Similarly, when the third magnet 103 faces the yokes 35 and 36 of the induction yoke part 3D, the magnetic flux flows in the −Y direction in the magnetic core 21. When the fourth magnet 104 faces the yokes 35 and 36 of the induction yoke part 3D, the magnetic flux flows in the +Y direction in the magnetic core 21.

In this way, the displacement of the magnet part 1D in the Z direction causes the direction of the magnetic flux in the magnetic core 21 to alternately reverse in the −Y and the +Y directions, and thus a high pulse voltage can be output from the coil 22. That is, in the first to fourth embodiments, electric power is generated by horizontally swinging the power generation modules 6, but in the fifth embodiment, electric power is generated by vertically swinging the power generation module 6D.

The pulse voltage output from the coil 22 is sent to a processor 70 (FIG. 21) mounted on the circuit board 7 via wires not illustrated.

FIG. 21 is a block diagram illustrating an example of the processor 70. The processor 70 has a rectifier element 71 that rectifies the pulse voltage from the coil 22 and an electric storage 72 that stores the voltage rectified by the rectifier element 71. Thus, the electric power generated by the power generation element 2 is charged in the electric storage 72. The electric power stored in the electric storage 72 can be taken out through terminals E1 and E2. In this case, the power generation module 6D is used as a rechargeable battery.

FIG. 22(A) is a diagram illustrating an example of the shape of the housing 8 of the power generation module 6D. The housing 8 illustrated in FIG. 22(A) has a cylindrical shape whose length in the axial direction is longer than its diameter. The housing 8 desirably has the same shape as that of a D, C, AA, or AAA dry cell battery, for example. The shapes of the D, C, AA and AAA dry cell batteries are the shapes specified by R20, R14, R6 and R03, respectively, in compliance with the JIS standard (JIS_C8500:2017).

FIG. 22(B) is a diagram illustrating another example of the shape of the housing 8. The housing 8 illustrated in FIG. 22(B) is a flattened cylindrical shape whose length in the axial direction is shorter than its diameter. The housing 8 desirably has the same shape as that of a button battery. The shape of the button battery is the shape specified by R41, R43, R44, R48, R54, R55, R70, or the like in compliance with the JIS standard (JIS_C8500:2017).

With such a configuration, the rechargeable batteries that are recharged by vibration of the movement of humans or machines or by vibration in the environment such as wind power can be used interchangeably with dry cell batteries or button batteries.

In this example, the processor 70 is installed inside the housing 8 of the power generation module 6D, but the processor 70 may be installed outside the housing 8. Further, a rechargeable battery, such as a commercially available secondary battery, may be installed outside the housing 8.

In this case, as illustrated in FIG. 23, the processor 70 has the rectifier element 71 that rectifies the pulse voltage from the coil 22 and an output processor 73 that supplies the voltage rectified by the rectifier element 71 through the terminals E1 and E2 to the rechargeable battery such as a secondary battery. Consequently, the electric power generated by the power generation element 2 is supplied to a secondary battery 9. In this case, the power generation module 6D is used as a charger.

The power generation module 6D of the fifth embodiment may be provided with the spring 56 described in the first and fourth embodiments. Thus, for example, small vibration of machinery that vibrates regularly may be amplified using the spring 56 so as to perform regular charging.

The features of the respective embodiments can be combined to each other. For example, the rechargeable battery or charger described in the fifth embodiment may be configured by using the power generation modules 6, 6A, 6B, and 6C of the first to fourth embodiments.

Although the desirable embodiments have been specifically described above, the present disclosure is not limited to the above embodiments, and various modifications and changes can be made to those embodiments.

### DESCRIPTION OF REFERENCE CHARACTERS

1, 1A, 1B, 1C, 1D: magnet part, 2: power generation element, 3, 3A, 3B, 3C, 3D: induction yoke part, 4: shield, 5, 5D: casing, 6, 6A, 6B, 6C, 6D: power generation module, 7: circuit board, 8: rechargeable battery, 9: casing, 11: first magnet, 12: second magnet, 13: third magnet, 14: fourth magnet, 15, 16, 17: spacer, 18: first magnet, 19: second magnet, 21: magnetic core, 22: coil, 30: package, 31, 33: first induction yoke, 32, 34: second induction yoke, 35: third induction yoke, 36: fourth induction yoke, 41: first shielding yoke, 42: second shielding yoke, 50: recess, 56: spring, 70: processor, 71: rectifier element, 72: electric storage, 73: signal processing circuit, 81: casing, 101: first magnet, 102: second magnet, 103: third magnet, 104: fourth magnet, 105, 106, 107: spacer, 111, 121, 131, 141, 181, 191: N-pole part, 112, 122, 132, 142, 182, 192: S-pole part.

1. A power generation module comprising:
a power generation element having a magnetic core elongated in one direction and a coil wound around the magnetic core;
an induction yoke part having a first induction yoke contacting one end of the magnetic core in a longitudinal direction of the magnetic core and made of a magnetic material and a second induction yoke contacting the other end of the magnetic core in the longitudinal direction and made of a magnetic material; and
a magnet part that is relatively displaceable relative to the power generation element in a direction perpendicular to the longitudinal direction, the magnet part having a first magnet and a second magnet arranged in its displacement direction,
wherein the first magnet has an N-pole part and an S-pole part arranged in the longitudinal direction,
wherein the second magnet has an S-pole part and an N-pole part arranged in the longitudinal direction,
wherein the N-pole part of the first magnet and the S-pole part of the second magnet face each other in the displacement direction, while the S-pole part of the first magnet and the N-pole part of the second magnet face each other in the displacement direction,
wherein, when the magnet part is located in a first position relative to the power generation element, the N-pole part of the first magnet faces the first induction yoke, while the S-pole part of the first magnet faces the second induction yoke, and
wherein, when the magnet part is located in a second position relative to the power generation element, the S-pole part of the second magnet faces the first induction yoke, while the N-pole part of the second magnet faces the second induction yoke.

2. The power generation module according to claim 1, further comprising a spacer disposed between the first magnet and the second magnet in the displacement direction and made of a non-magnetic material.

3. The power generation module according to claim 2, wherein a width of the spacer in the displacement direction is wider than a width of the first magnet in the displacement direction and wider than a width of the second magnet in the displacement direction.

4. The power generation module according to claim 2, wherein a shortest distance between the magnet part and the induction yoke part is narrower than a width of the spacer in the displacement direction.

5. The power generation module according to claim 1, further comprising a shielding yoke disposed on at least one side of the induction yoke part in the displacement direction and made of a magnetic material.

6. The power generation module according to claim 5, wherein the shielding yoke has a length longer than or equal to a total length of the N-pole part and the S-pole part of the first magnet in the longitudinal direction.

7. The power generation module according to claim 1, wherein the induction yoke part comprises:
a third induction yoke on the magnet part side relative to the first induction yoke, and
a fourth induction yoke on the magnet part side relative to the second induction yoke.

8. The power generation module according to claim 1, further comprising a casing holding the magnet part so that the magnet part is displaceable in the displacement direction,
wherein the power generation element and the induction yoke part are fixed to the casing, and
wherein a distance by which the magnet part is displaceable in the casing is at least double an interval between the first magnet and the second magnet in the displacement direction.

9. The power generation module according to claim 1, further comprising a spring urging the magnet part toward one side in the displacement direction.

10. The power generation module according to claim 1, wherein each of the first magnet and the second magnet has a magnetization direction in a direction perpendicular to both the longitudinal direction and the displacement direction, and
wherein the first induction yoke and the second induction yoke are disposed on one side in the magnetization direction relative to the magnet part.

11. The power generation module according to claim 1, wherein each of the first magnet and the second magnet has a magnetization direction in the longitudinal direction, and
wherein the first induction yoke and the second induction yoke are disposed on both sides of the magnet part in the longitudinal direction.

12. The power generation module according to claim 1, wherein the magnet part further has a third magnet and a fourth magnet which are arranged in the displacement direction.

13. The power generation module according to claim 1, further comprising an electric storage connected to the coil of the power generation element and storing an electric charge due to a pulse voltage generated by the power generation element.

14. The power generation module according to claim 1, further comprising a rectifier element connected to the coil of the power generation element and rectifying a pulse voltage generated by the power generation element.

15. The power generation module according to claim 14, further comprising an output unit connected to the rectifier element and outputting the pulse voltage generated by the power generation element to a secondary battery.

16. The power generation module according to claim 1, further comprising a housing that houses the power generation element, the magnet part, and the induction yoke part,
wherein the housing has a same shape as a D, C, AA, or AAA dry cell battery, or a same shape as a button battery.
